(19) United States
(12) Patent Application Publication
(10) Pub. No.: US 2014/0178143 A1
(43) Pub. Date: Jun. 26, 2014

(54) WORKPIECE ABUTMENT STRUCTURE FOR A MILLING MACHINE

(71) Applicant: RAJALAMPI OY, Iittala (FI)

(72) Inventor: Vesa RAJALAMPI, IITTALA (FI)

(73) Assignee: RAJALAMPI OY, IITTALA (FI)

(21) Appl. No.: 13/723,914

(22) Filed: Dec. 21, 2012

(51) Int. Cl. B23Q 3/18

(52) U.S. Cl. CPC B23Q 3/18
USPC 409/218

(57) ABSTRACT

A workpiece abutment structure for a milling machine to carry out accurate positioning of the workpiece during the machining includes a body element to be supported to a bench of the milling machine and a number of support elements shaped as a rectangular parallelepiped and mountable in a superposed configuration to one another into a support post of a desired height. Further, the structure includes a number of straight abutment bars and corresponding support holes and lockings in the support elements to push the abutment bar through the support element and lock it in a desired position. In addition, the abutment structure has a locking bar, and the support elements have a corresponding hole to lock the support elements to one another into a support post of a desired height.

### FIELD OF THE INVENTION

The invention relates to an abutment structure for a workpiece to be machined in a milling machine to achieve accurate positioning of the workpiece during the machining.

### BACKGROUND OF THE INVENTION

The milling machine is a machine tool with a rotating cutter by which material is machined, i.e. removed, from the workpiece to provide a desired shape. Normally, the workpiece is kept stationary and the cutter of the milling machine is moved in different directions to achieve the desired shape of the workpiece.

In particular in manufacturing series, i.e. a number of completely identical pieces, successively by a single milling machine, the workpieces must be accurately positioned in the same place for the duration of the machining to become identical. This is not a problem in large series, as it is easy to build the milling machine with almost fixed support structures that can be kept in their position for long periods. However, in manufacturing small series with an equivalent need to make all parts of the series identical, the problem is to build for workpieces a support abutment that determines the precise position of the workpiece but can be easily removed and changed and shaped in a manner as required by shapes of the pieces in the next series.

### OBJECTIVE OF THE INVENTION

The objective of the invention is to remedy the above-mentioned defects of prior art. In particular, the objective of the invention is to disclose a novel workpiece abutment structure for a milling machine, allowing one quickly and easily to modify and change the abutments used and providing unlimited possibilities to form different-sized and different-shaped abutment surfaces.

### SUMMARY OF THE INVENTION

The invention relates to an abutment structure for a workpiece to be machined in a milling machine, enabling accurate positioning of the workpiece for the duration of the machining. The abutment structure according to the invention includes a body element to be supported to a bench of the milling machine and a number of support elements shaped as a rectangular parallelepiped and mountable to one another in a superposed configuration as a support post of a desired height. The number of the support elements may vary case-specifically, always according to the size of the workpiece. Further, the abutment structure includes a number of straight abutment bars and corresponding support holes and lockings in the support elements. Thus, a suitable number, one or more abutment bars can be pushed through the support element or support elements and locked in a desired position in such a way that ends of the abutment bars form accurate support points against which a workpiece to be positioned is closely supported. In addition, the abutment structure according to the invention has a locking bar and a corresponding hole in each support element in such a way that the support elements can be locked to one another as a support post of a desired height.

The support element shaped as a rectangular parallelepiped includes six faces, i.e. an upper surface, lower surface, two lateral surfaces and two end surfaces.

Thus, the support holes are arranged to extend straight through the support element from one end surface to the other. Preferably, one support element has a number of superposed and parallel support holes extending from one end surface to the other through the support element. Thus, it is possible to support an abutment bar at a different height in one support element as needed or to support a number of abutment bars in the same support element.

Locking in place of the abutment bar is carried out simply by an arrangement extending perpendicularly into the support hole from a lateral surface of the support element, wherein a locking screw can be turned onto the abutment bar in the hole. In a preferred embodiment of the invention, the locking screw does not, however, come into contact with the abutment bar; instead, a locking plug is provided in the hole for the locking screw between same and the abutment bar. The locking plug is made of a suitably soft metal, i.e. a metal softer than the abutment bar, such as brass. In addition, there are no threads on the locking plug; instead, there may even be guides preventing it from turning in the hole. Alternatively, the tip thereof may have a concave shape corresponding to the shape of the abutment bar. At least, it develops, when pressed in place towards the abutment bar, a shape, i.e. a slot, corresponding to the shape of the surface of the abutment bar. This way, the locking plug does not turn towards the abutment bar when the locking screw is tightened. This non-turning character, i.e. direct pressing of the abutment bar in place, ensures positioning accuracy for the locking bar. In other words, the abutment bar positioned in place against a workpiece stays precisely stationary when locked in position.

In one embodiment of the invention, height setting plates, i.e. thin plates of a thickness of a few millimeters, corresponding to support elements in terms of shape and configuration of holes can be used between the support elements. These allow making more specific height adjustments for the support posts and abutment bars extending therefrom.

To securely make the support elements stay stationary relative to one another even in a high support post, at least two alignment holes are provided in one embodiment of the invention to the upper surface and lower surface of the support element in aligned positions. Further, the abutment structure includes a number of alignment pins to be located in the alignment holes. Thus, by positioning, for example into the alignment holes of a lower support element, alignment pins of a length greater than the depth of said holes and by pressing a second support element on top of the first one in such a way as to drive the alignment pins into the alignment holes of the lower surface in the second support element, the support elements settle accurately and with non-turning rigidity in their position in a superposed configuration.

### ADVANTAGES PROVIDED BY THE INVENTION

The abutment structure according to the invention for a workpiece to be machined in a milling machine has considerable advantages as compared to prior art. The invention is simple and easy to use. Just by selecting a suitable number of different support elements and abutment bars it is possible always to form a sufficient number of the abutment surfaces or abutment points in such a way that workpieces are always firmly secured in the same place during machining. In addition, nothing prevents one from making two separate support posts with the abutment bars if for some reason one does not suffice. Further, as a modular structure, it can be easily extended just by providing new parts as needed.

### BRIEF DESCRIPTION OF THE DRAWINGS

The invention will be described in detail below with reference to the accompanying drawings, in which

FIG. 1 schematically illustrates a milling machine provided with an abutment structure,

FIG. 2 illustrates one body element according to the invention,

FIG. 3 illustrates one support element according to the invention,

FIG. 4 illustrates the support element of FIG. 3 with additional fittings,

FIG. 5 illustrates one height setting plate according to the invention,

FIG. 6 illustrates one abutment structure according to the invention in working order and

FIG. 7 illustrates one detail of the invention.

### DETAILED DESCRIPTION OF THE INVENTION

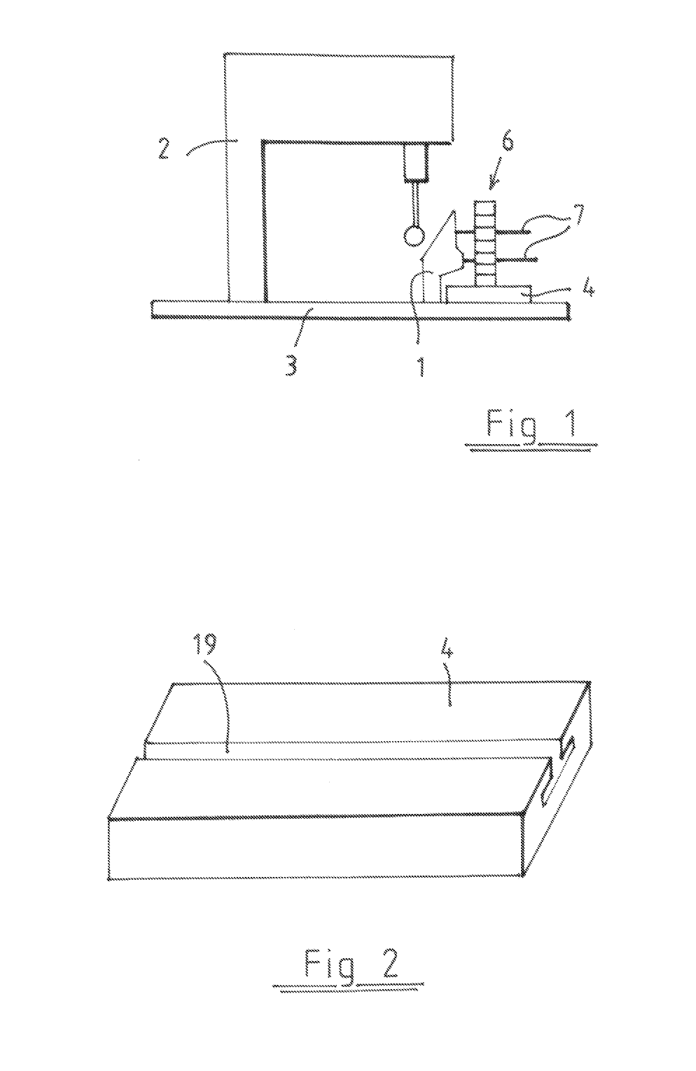

FIG. 1 generally and schematically illustrates a milling machine 2 and a bench 3 thereof supporting both a workpiece 1 to be milled and an abutment structure according to the invention, wherein, by means of a body element 4, a support post 6 and abutment bars 7, the workpiece 1 is provided an accurately defined position on the milling bench. The invention is described in more detail below with reference to the other figures.

The abutment structure according to the invention includes a body element 4, for example in FIG. 2, formed by a robust beam, on top of which there is provided in a longitudinal direction thereof a mounting slot 19, a T-slot, to which the support post 6 is mountable. Although not drawn in FIG. 2, the lower surface of the body element may be provided with different slots, threaded holes or other shapes enabling the firm mounting thereof to a desired position in the bench 3 of the milling machine 2.

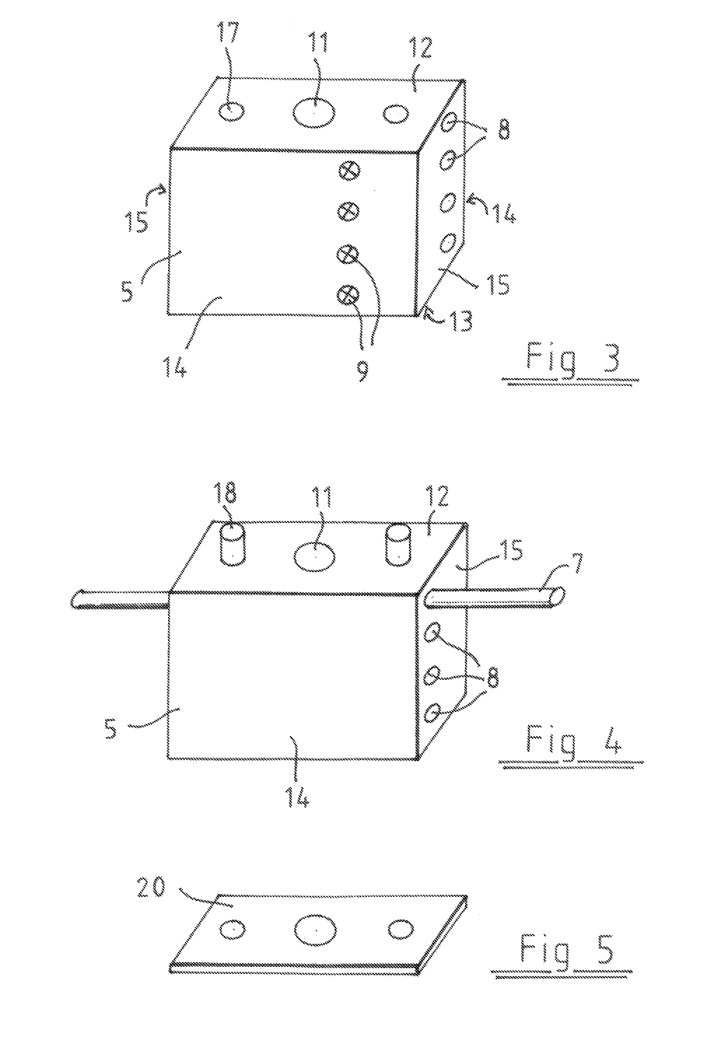

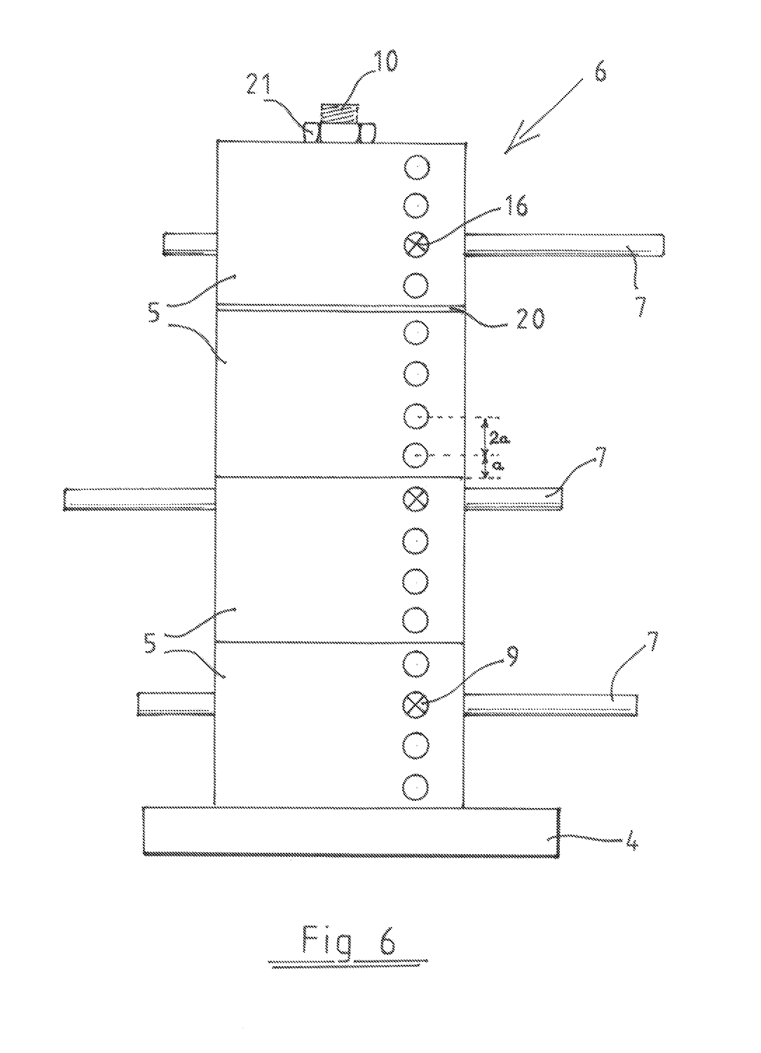

The most essential part of the invention is a support element 5 shaped as a rectangular parallelepiped as illustrated in FIGS. 3 and 4. The support element includes straight and planar upper surface 12, lower surface 13, two lateral surfaces 14 and two end surfaces 15. The abutment structure according to the invention always includes a number of identical support elements, the number depending on the height and size of the support structure required.

A hole 11 is drilled perpendicularly downward right from the middle of the upper surface 12 of the support element 5 to the middle of the lower surface 13 thereof. Further, the upper surface of the support element is provided on both sides of the hole 11 with smaller alignment holes 17 extending only to a small distance, for example for approximately 10 mm, into the support element from the upper surface thereof. Two corresponding alignment holes are also made to the lower surface of the support element. Thus, by locating, according to FIG. 4, alignment pins 18 in the alignment holes 17, it is possible to stack the support elements 5 in a superposed configuration according to FIG. 6 in a desired number. The alignment holes and alignment pins therein ensure that the support elements are precisely and closely disposed one on the other.

The support elements 5 located in a superposed configuration are mounted to one another and to the body element 4 by a locking bar 10, i.e. a threaded bar. A connection element known per se for mounting to the mounting slot 19 of the body element 4 is disposed at the lower end thereof, and a nut 21 is threaded to the upper end of the threaded bar extending further than the uppermost support element. Thus, the support elements can be tightened into a stiff and straight support post 6.

In addition to the vertical holes described above, the support element according to the figures has four superposed support holes 8 extending in parallel from one end surface 15 of the support element to the other perpendicularly to the end surfaces. The support holes are disposed at an even distance 2a from one another, FIG. 6. Further, the uppermost and the lowermost hole is disposed at a distance a from the upper surface and the lower surface in such a way that the support holes in the support elements positioned in a superposed configuration are disposed at a constant distance 2a from one another in the entire support post 6. An exception is the use of a height setting plate according to FIG. 5, described in more detail below.

Further, the support hole 8 can be provided with a straight abutment bar 7 extending through the support element. Extending perpendicularly into each support hole from the lateral surface 14 of the support element is a locking 9, i.e. a hole, with a locking screw 16. Thus, an abutment bar 7 can be pushed into the desired support holes 8 for a required distance and locked in position.

In addition, it is possible to use thin height setting plates 20 according to FIG. 5 between the support elements 5, the height setting plates corresponding in a horizontal cross section to the upper surface or lower surface of the support element, i.e. they have a hole 11 and alignment holes 17. The height setting plates can be used to fine-tune the height of the support posts and thus the more precise height position of abutment bars 7 extending sidewardly therefrom relative to a workpiece to be machined.

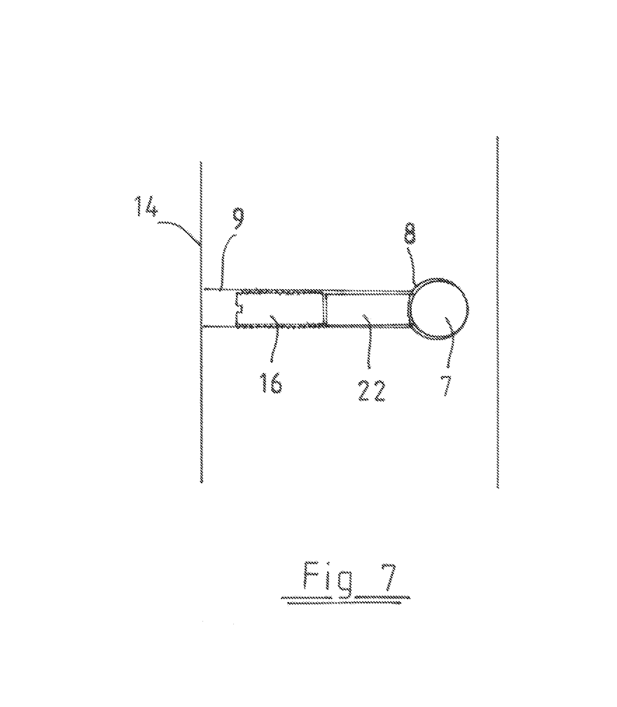

FIG. 7 illustrates a preferred embodiment of the invention to ensure that an abutment bar 7 be accurately positioned and kept stationary. A locking hole 9 extending from a lateral surface 14 is provided with a locking screw 16, and a locking plug 22 is provided to the tip thereof, i.e. between it and the abutment bar 7 in the transverse support hole 8. The locking plug 22 is made of brass or other metal softer than the metal of the abutment bar so as to be pressed and to a degree reshaped against the abutment bar. Thus, turning of the locking screw does not have any effect on the abutment bar and move it in a longitudinal direction; instead, the abutment bar is only subjected to purely transverse pressure locking it exactly where it has been positioned against a workpiece 1 in FIG. 1.

One abutment structure according to the invention as illustrated in the figures is used as follows. When it is desirable to have workpieces to be milled always precisely in the same position for the duration of machining, a sufficiently high support post 6 is composed of support elements 5 and mounted on the milling bench 3, and the support elements are tightened against one another into a rigid assembly. After this, one or more abutment bars 7 are pushed through the support holes 8 in such a way that their one end meets the workpiece 1 that is stationary in the appropriate machining position. The abutment bars are locked in this position. A sufficient number or the abutment bars is used at different heights in such a way that the ends thereof define the precise position of a workpiece. If necessary, it is even possible to mount another support post 6 with the abutment bars onto a milling bench. It is essential that the abutment bars are used in a sufficient number at different heights as surely and precisely to define the precise position of a workpiece.

The invention has been described above by way of example with reference to the accompanying drawings; however, different embodiments of the invention are possible within the scope defined by the claims.

1. A workpiece abutment structure for a milling machine to carry out accurate positioning of the work-piece during the machining, the abutment structure including; a body element to be supported to a bench of the milling machine; a number of support elements shaped as a rectangular parallelepiped and mountable to one another in a superposed configuration as a support post of a desired height; a number of straight abutment bars and corresponding support holes and lockings in the support elements to push the abutment bar through the support element and lock it in a desired position; and a locking bar and a corresponding 15 hole in the support elements to lock the support elements to one another into a support post of a desired height.

2. The abutment structure according to claim 1, where in the support element includes an upper surface, a lower surface, two lateral surfaces and two end surfaces, and the support holes are arranged to extend through the support element from one end surface to the other.

3. The abutment structure according to claim 1, wherein an arrangement that extends to the support hole from the lateral surface and is provided with a locking screw forms the locking.

4. The abutment structure according to claim 3, wherein the arrangement includes, between the locking screw and abutment bar to be locked, a locking plug that is non-turnable relative to the abutment bar and made of a metal softer than the abutment bar.

5. The abutment structure according to claim 1, wherein the upper surface and the lower surface of the support element include, in aligned positions, at least two alignment holes, and the abutment structure includes a number of alignment pins to be located in the alignment holes for accurately aligning the support elements in a superposed configuration into a support post.

6. The abutment structure according to claim 1, wherein the body element has an upwards opening mounting slot to support the lower end of the locking bar to the body element.

7. The abutment structure according to claim 1, wherein the support element includes a number of superposed and parallel support holes extending from one end surface to the other through the support element.

8. The abutment structure according to claim 1, comprising at least one height setting plate which is provided with holes corresponding to the lower surface of the support element for being located between two support elements.

9. The abutment structure according to claim 2, wherein an arrangement that extends to the support hole from the lateral surface and is provided with a locking screw forms the locking.

10. The abutment structure according to claim 9, wherein the arrangement includes, between the locking screw and abutment bar to be locked, a locking plug that is non-turnable relative to the abutment bar and made of a metal softer than the abutment bar.
